(19) United States
(12) Patent Application Publication
(10) Pub. No.: US 2002/0063395 A1
(43) Pub. Date: May 30, 2002

(54) Metal cylinder head gasket

(76) Inventors: Manfred Klinner, Koln (DE); Timo Walz, Gondelsheim (DE); Klaus Bendl, Bretten (DE); Ralf Salameh, Bretten (DE); Alain Retiere, Erkrath (DE)

Correspondence Address: VENABLE, BAETJER, HOWARD AND CIVILETTI, LLP, P.O. BOX 34385, WASHINGTON, DC, 20043-9998, US

(21) Appl. No.: 09/991,977

(22) Filed: Nov. 26, 2001

(30) Foreign Application Priority Data
Nov. 24, 2000 (DE) 100 58 495.0

(51) Int. Cl. F02F 11/00

(52) U.S. Cl. 277/592

(57) ABSTRACT

A cylinder head gasket includes a metal gasket plate; a lubricant aperture provided in the plate for serving as a passage for a lubricant; a lubricant aperture seal surrounding the lubricant aperture and being of a lubricant-resistant material; a coolant aperture provided in the plate for serving as a passage for a coolant; a coolant aperture seal surrounding the coolant aperture and being of a coolant-resistant material; and a single coupling agent coating provided on the plate. The coupling agent coating is of a material which bonds the lubricant aperture seal and the coolant aperture seal to the plate.

### CROSS REFERENCE TO RELATED APPLICATION

This application claims the priority of German Application No. 100 58 495.0 filed Nov. 24, 2000, which is incorporated herein by reference.

### BACKGROUND OF THE INVENTION

This invention relates to a cylinder head gasket for internal-combustion engines. The gasket is composed of a single metal plate or superposed metal plates having separate through apertures for the passage of a coolant and a lubricant. The apertures are surrounded by sealing elements made of an elastomer or a hard plastic material. The material of the sealing elements is different, dependent on the nature of the liquid contacted by the sealing element.

To provide a cylinder head gasket which does not appreciably deform in use and wherein a re-tightening of the gasket-clamping bolts is not necessary, it has been known to use single-layer or multi-layer metal cylinder head gaskets, particularly in internal-combustion engines operating with high combustion pressures. The individual metal layers are preferably of steel and in case of a multi-layer construction, the individual layers may have different properties. Thus, for example, the outer layers may consist of thin, elastic, hard steel sheets whereas the inner layers may be thicker and softer steel sheets.

In metal cylinder head gaskets, particularly because of the only slight plastic deformability thereof, difficulties have been encountered in sealing the through apertures for the lubricant oil for the engine or the coolant for the combustion chambers. Such aperture regions have been usually sealed by elastomer or plastomer sealing elements. It has thus been long known to seal the through apertures by sprayed-on sealing elements. Such a manufacturing process is disclosed in British Patent No. 852,413. The sealing elements provided for the individual through apertures are all made of the same material.

Engines of current design require increasingly improved sealing zones. Since the material for sealing the coolant passages must comply with requirements other than a material for sealing lubricant passages, it is not an optimal solution to provide all the through openings with seals having one and the same material.

For solving the above problem, cylinder head gaskets have been designed in which the different through openings have been sealed with elastomer sealing elements whose material is selected dependent on the liquid passing through the respective apertures. Such an arrangement is disclosed in German Patent No. 4,109,951 in which elastomer sealing elements are inserted into the through apertures of the cylinder head gasket. The sealing elements are manufactured as components separate from the gasket plate and are subsequently inserted into the through passages of the gasket plate and connected in a form-locking member therewith.

### SUMMARY OF THE INVENTION

It is an object of the invention to provide an improved cylinder head gasket of the above-outlined type in which sealing elements of unlike material may be directly sprayed on a gasket plate in a mass manufacturing process without increasing the manufacturing costs.

This object and others to become apparent as the specification progresses, are accomplished by the invention, according to which, briefly stated, the cylinder head gasket includes a metal gasket plate; a lubricant aperture provided in the plate for serving as a passage for a lubricant; a lubricant aperture seal surrounding the lubricant aperture and being of a lubricant-resistant material; a coolant aperture provided in the plate for serving as a passage for a coolant; a coolant aperture seal surrounding the coolant aperture and being of a coolant-resistant material; and a single coupling agent coating provided on the plate. The coupling agent coating is of a material which bonds the lubricant aperture seal and the coolant aperture seal to the plate.

By using a universal coupling agent, it is feasible to spray different sealing materials directly on the metal gasket plate without the need to manufacture separate components. Each sealing element is selected for its best behavior when contacted by the liquid it is intended to seal. The cost disadvantage thought heretofore is eliminated by the fact that for low requirements inexpensive materials may be used and the usual process, together with the logistics involved therewith and characterizing the manufacture of separate components may be dispensed with.

### BRIEF DESCRIPTION OF THE DRAWING

FIG. 1 is a top plan view of a cylinder head gasket incorporating the invention.

FIG. 2 is a sectional view taken along line II-II of FIG. 1.

### DESCRIPTION OF THE PREFERRED EMBODIMENT

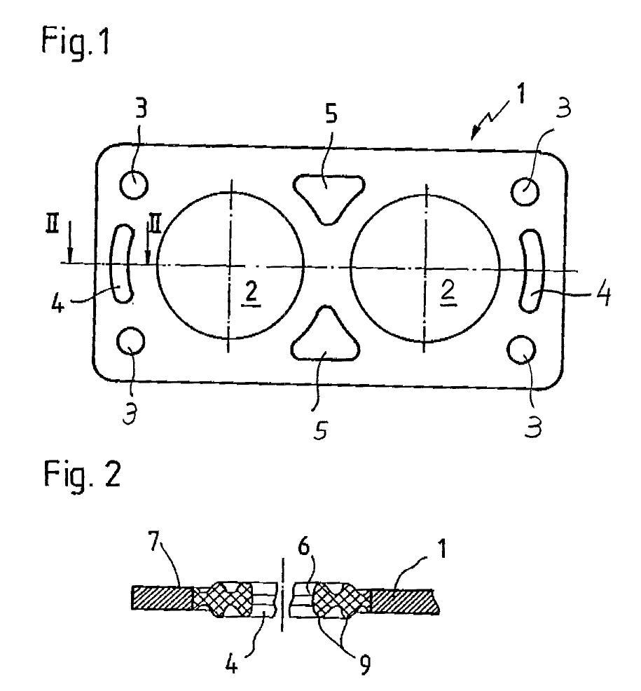

Turning to the FIGS. 1 and 2, the cylinder head gasket 1 is a single-layer metal construction; it is to be understood that the gasket may also be a multi-layer member having superposed metal plates. The cylinder head gasket 1 has a plurality of apertures 2, 3, 4 and 5. The apertures 2 surround, in the installed state of the cylinder head gasket 1, the combustion chambers of the engine cylinders whereas apertures 3, 4 and 5 serve for the passage of securing screws, lubricant and coolant, respectively.

Turning to FIG. 2, to the entire metal gasket plate, but at least to its regions about the apertures to be surrounded with sealing elements, a coupling agent coating 7 is applied which may be a silane based material. The coating may be applied by spraying or by submerging the gasket plate into a coupling agent bath. The coupling agent could be for example such as: Amino silane, epoxy silane, vinyl silane or mercapto silane.

The apertures, as shown for the aperture 4 in FIG. 2, are provided, by a spraying process, with a sealing element, designated at 6. The sealing element has, on its opposite faces, dual ribs 9 which project beyond the opposite surfaces of the gasket plate 1.

Similarly configured sealing elements may be provided for the apertures 5 serving for the passage of a coolant. The sealing elements for the apertures 4, on the one hand, and for the apertures 5, on the other hand, differ in the material designed to best withstand the effects of the different media passing through the respective apertures. Thus, the material of the sealing elements inserted in the apertures 4 is particularly lubricant-resistant whereas the material of the sealing element inserted in the apertures 5 is particularly designed to be coolant-resistant. The sealing elements are of an elastomer or rubber material such as HNBR or FPM or FPM-olefin copolymers. The lubricant-resistant material may be an elastomer or rubber, based on ethylene or acrylate, and the coolant-resistant material may be an elastomer and rubber, based on ethylene propylene or may be diene.

While the sealing elements associated with the apertures 4 and 5 are of different material, the universal coupling agent coating 7 ensures that they are firmly bonded to the metal gasket plate.

It will be understood that the above description of the present invention is susceptible to various modifications, changes and adaptations, and the same are intended to be comprehended within the meaning and range of equivalents of the appended claims.

What is claimed is:

1. A cylinder head gasket comprising
(a) a metal gasket plate;
(b) a lubricant aperture provided in the plate for serving as a passage for a lubricant;
(c) a lubricant aperture seal surrounding said lubricant aperture and being of a lubricant-resistant material;
(d) a coolant aperture provided in the plate for serving as a passage for a coolant;
(e) a coolant aperture seal surrounding said coolant aperture and being of a coolant-resistant material; and
(f) a single coupling agent coating provided on said plate; said coupling agent coating being of a material that bonds said lubricant aperture seal and said coolant aperture seal to said plate.

2. The cylinder head gasket as defined in claim 1, wherein said coupling agent coating covers said plate over the entire surface thereof.

3. The cylinder head gasket as defined in claim 1, wherein said lubricant aperture seal and said coolant aperture seal are sprayed-on seals.

4. The cylinder head gasket as defined in claim 1, wherein said coolant-resistant material is of one of an elastomer and rubber based on ethylene propylene.

5. The cylinder head gasket as defined in claim 1, wherein said coolant-resistant material is diene.

6. The cylinder head gasket as defined in claim 1 wherein said lubricant-resistant material is one of an elastomer and rubber based on one of ethylene and acrylate.

7. The cylinder head gasket as defined in claim 1, wherein said coupling agent coating is silane based.

8. The cylinder head gasket as defined in claim 1, wherein said lubricant aperture seal and said coolant aperture seal project beyond an upper surface of said plate.

9. The cylinder head gasket as defined in claim 8, wherein said lubricant aperture seal and said coolant aperture seal have dual ribs.
